(19) United States
(12) Patent Application Publication
(10) Pub. No.: US 2015/0262740 A1
(43) Pub. Date: Sep. 17, 2015

(54) RARE EARTH-COBALT PERMANENT MAGNET

(71) Applicant: NEC TOKIN Corporation, Sendai-shi (JP)

(72) Inventors: Teruhiko FUJIWARA, Sendai-shi (JP); Hiroaki MACHIDA, Sendai-shi (JP); Hideyuki YOSHIKAWA, Sendai-shi (JP)

(21) Appl. No.: 14/643,875

(22) Filed: Mar. 10, 2015

(30) Foreign Application Priority Data
Mar. 11, 2014 (JP) 2014-047031

(51) Int. Cl. H01F 1/055; C22C 30/02; C22C 19/07

(52) U.S. Cl. CPC H01F 1/055; C22C 19/07; C22C 30/02

(57) ABSTRACT

There is provided a rare earth-cobalt permanent magnet containing 23 to 27 wt % R, 3.5 to 5 wt % Cu, 19 to 25 wt % Fe, 1.5 to 3 wt % Zr, and a remainder Co with inevitable impurities, where an element R is a rare earth element at least containing Sm. The rare earth-cobalt permanent magnet has a density of 8.15 to 8.39 g/cm³. It also has a metal structure including a cell phase (11) containing Sm₂Co₁₇ phase and a cell wall (12) surrounding the cell phase and containing SmCo₅ phase. An average crystal grain diameter is within a range of 40 to 100 μm. A half width of Cu content of the cell wall (12) is 10 nm or less.

### INCORPORATION BY REFERENCE

This application is based upon and claims the benefit of priority from Japanese patent application No. 2014-047031, filed on Mar. 11, 2014, the disclosure of which is incorporated herein in its entirety by reference.

### BACKGROUND OF THE INVENTION

1. Field of the Invention The present invention relates to a rare earth-cobalt permanent magnet.

2. Description of Related Art

Examples of rare earth-cobalt permanent magnets include a samarium-cobalt magnet that contains 14.5 wt % Fe. Further, a samarium-cobalt magnet with higher Fe content is made to improve the energy product.

For example, the samarium-cobalt magnet obtained using an alloy consisting of 20 to 30 wt % RE (RE is Sm or two or more kinds of rare earth elements containing 50 wt % or more Sm), 10 to 45 wt % Fe, 1 to 10 wt % Cu, 0.5 to 5 wt % Zr, and the remainder Co with inevitable impurities is disclosed in Japanese Unexamined Patent Application Publication No. 2002-083727. To be specific, strip casting is used to cast the alloy and obtain a thin piece. The strip casting is a method that drops the molten alloy onto a water-cooled copper roll and produces a thin piece with a thickness of about 1 mm Then, the obtained thin piece is placed in a non-oxidizing atmosphere and heat-treated, then ground to powder. The powder is then compression-molded in a magnetic field and further undergoes sintering, solution treatment and ageing treatment in this order.

### SUMMARY OF THE INVENTION

The above-described strip casting requires a complex device such as a water-cooled copper roll. Thus, there is a demand to produce the above-described rare earth-cobalt permanent magnet by using metal mold casting that allows casting with a simple device compared with the strip casting. However, producing a permanent magnet by using such metal mold casting fails to obtain good magnetic properties in some cases.

The present invention has been accomplished in view of the above-noted circumstances, and an object of the present invention is thus to provide a rare earth-cobalt permanent magnet with good magnetic properties that can be produced using a simple device.

A rare earth-cobalt permanent magnet according to the present invention is a rare earth-cobalt permanent magnet containing 23 to 27 wt % R, 3.5 to 5 wt % Cu, 19 to 25 wt % Fe, 1.5 to 3 wt % Zr, and a remainder Co with inevitable impurities, where an element R is a rare earth element at least containing Sm, wherein the rare earth-cobalt permanent magnet has a density of 8.15 to 8.39 g/cm³ and has a metal structure including a cell phase containing Sm₂Co₁₇ phase and a cell wall surrounding the cell phase and containing SmCo₅ phase, an average crystal grain diameter is within a range of 40 to 100 μm, and a half width of Cu content of the cell wall is 10 nm or less.

According to the present invention, it is possible to provide a rare earth-cobalt permanent magnet with good magnetic properties that can be produced using a simple device.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a flowchart showing a rare earth-cobalt permanent magnet production method according to a first embodiment;

FIG. 2 is a cross-sectional photograph showing a microstructure in an example 1;

FIG. 3 shows each composition with respect to distance in the example 1;

FIG. 4 is a cross-sectional photograph showing a microstructure in a comparative example 1; and

FIG. 5 shows each composition with respect to distance in the comparative example 1.

### DESCRIPTION OF THE EXAMPLARY EMBODIMENTS

The present inventors have found that it is important that the composition is homogenized in a microstructure in solution treatment and thus focused attention on raw material preparation. Particularly, among the element content of the rare earth-cobalt permanent magnet, the melting point of pure Zr is 1852° C., which is far higher than about 1400° C., the melting point of an alloy having the same composition as the permanent magnet, and therefore there has been a concern about the uneven distribution of the element Zr in the microstructure. The present inventors have made intensive studies on a raw material, a production method and the like and have accomplished the present invention.

### First Embodiment

A rare earth-cobalt permanent magnet according to a first embodiment is described hereinafter.

The rare earth-cobalt permanent magnet according to the first embodiment contains 23 to 27 wt % R, 3.5 to 5 wt % Cu, 19 to 25 wt % Fe, 1.5 to 3 wt % Zr, and the remainder Co with inevitable impurities. The melting point of the rare earth-cobalt permanent magnet according to the first embodiment is about 1400° C. R is a rare earth element and at least contains Sm among rare earth elements. Examples of rare earth elements include Pr, Nd, Ce and La. Further, the rare earth-cobalt permanent magnet according to the first embodiment contains an intermetallic compound that is composed predominantly of rare earth cobalt. The intermetallic compound may be SmCo₅, Sm₂Co₁₇ or the like, for example.

Further, the rare earth-cobalt permanent magnet according to the first embodiment has a metal structure containing crystal grains. The crystal grains have a cell phase containing Sm₂Co₁₇, a cell wall surrounding the cell phase and containing SmCo₅, and a plate phase containing Zr. Further, in the rare earth-cobalt permanent magnet according to the first embodiment, a structure in a sub-micron size is formed inside the crystal grain, and further a concentration difference in an alloy composition exists between the cell phase and the cell wall, and particularly, Cu is concentrated on the cell wall. The rare earth-cobalt permanent magnet according to the first embodiment contains more Fe than the existing samarium-cobalt magnet. Accordingly, the rare earth-cobalt permanent magnet according to the first embodiment has a high coercive force and high squareness as the magnetic properties. Further, as Cu is concentrated on the cell wall, the squareness of the rare earth-cobalt permanent magnet is expected to increase.

The rare earth-cobalt permanent magnet according to the first embodiment can be widely used as various parts of a clock, an electric motor, a measuring instrument, telecommunication equipment, a computer terminal, a speaker, a video disk, a sensor and other equipment. Further, because the magnetic force of the rare earth-cobalt permanent magnet according to the first embodiment resists being degraded under high ambient temperature, and application to an angle sensor, an ignition coil used in a vehicle engine room, a drive motor of HEV (Hybrid electric vehicle) and the like is expected.

### Production Method

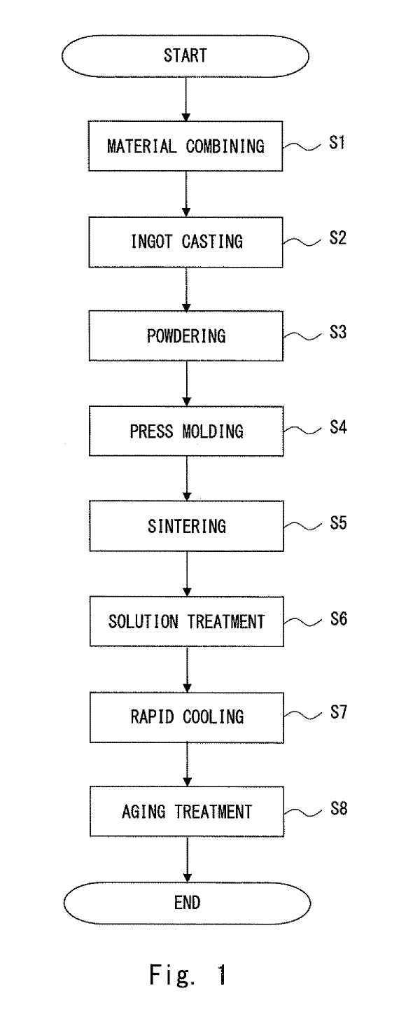

A method of producing the permanent magnet according to the first embodiment is described hereinafter with reference to FIG. 1.

First, a rare earth element, pure Fe, pure Cu, pure Co, and a master alloy containing Zr are prepared as raw materials, and those materials are combined in the above-described specified composition (material combining step S1). The master alloy is a binary alloy that generally consists of two different metal elements and is used as a dissolving material. Further, the master alloy containing Zr has a composition with a lower melting point than 1852° C., the melting point of pure Zr. The melting point of the master alloy containing Zr is preferably equal to or lower than the temperature that dissolves the rare earth-cobalt permanent magnet according to the first embodiment, which is 1600° C. or lower, and more preferably 1000° C. or lower.

Examples of the master alloy containing Zr include FeZr alloy and CuZr alloy. The FeZr alloy and CuZr alloy are preferable because they have a low melting point and therefore Zr is dispersed uniformly throughout an ingot structure, which is described later. Accordingly, the FeZr alloy and CuZr alloy having an eutectic composition or a similar composition are preferable because the melting point is suppressed to be 1000° C. or lower. To be specific, the FeZr alloy is 20% Fe-80% Zr alloy, for example. The 20% Fe-80% Zr alloy contains 75 to 85wt % Zr and the remainder Fe with inevitable impurities. The CuZr alloy is 50% Cu-50% Zr alloy, for example. The 50% Cu-50% Zr alloy contains 45 to 55wt % Zr and the remainder Cu with inevitable impurities.

Then, the combined materials are charged into an alumina crucible, dissolved by a high-frequency furnace under a vacuum atmosphere or under an inert gas atmosphere with 1×10⁻²Torr or less, and then casted into a metal mold, thereby obtaining an ingot (ingot casting step S2). The casting method is a method called book molding, for example. Note that the obtained ingot may be heat-treated for about 1 to 20 hours at a solution temperature. By this heat treatment, the structure of the ingot is further homogenized, which is preferable.

Then, the obtained ingot is ground to powder having a specified average particle diameter (powdering step S3). Typically, the obtained ingot is coarsely ground, and further the coarsely ground ingot is finely ground to powder in an inert gas atmosphere by using a jet mill or the like. The average particle diameter (d50) of the powder is 1 to 10 μm, for example. Note that the average particle diameter (d50) is a particle diameter at an integrated value 50% in the particle size distribution obtained by the laser diffraction and scattering method.

After that, the obtained powder is placed in a certain magnetic field, and further the powder is pressurized vertically to the magnetic field and press-molded, thereby obtaining a molded body (press molding step S4). The press molding conditions are a magnetic field of 15 kOe or higher, and a pressure value of press molding of 0.5 to 2.0 ton/cm², for example.

Then, the molded body is heated to a sintering temperature under a vacuum atmosphere or under an inert gas atmosphere with 1×10⁻²Torr or less and thereby sintered (sintering step S5). The sintering temperature is 1150° C. to 1250° C., for example.

Then, the molded body is solution-treated at a solution temperature that is lower than the sintering temperature by 20° C. to 70° C. under the same atmosphere condition (solution treatment step S6). The solution time is 2 to 10 hours, for example. Note that the solution time may be varied appropriately according to the structure of the obtained molded body and the target magnetic properties. If the solution time is too short, the composition is not sufficiently homogenized. On the other hand, if the solution time is too long, Sm contained in the molded body evaporates. This produces a difference in composition between the inside and the surface of the molded body, which can cause the degradation of the magnetic properties as a permanent magnet.

Note that, it is preferred to perform the sintering step S5 and the solution treatment step S6 in succession in terms of mass production. In the case of performing the sintering step S5 and the solution treatment step S6 in succession, the temperature is dropped from the sintering temperature to the solution temperature at a low temperature drop rate such as 0.2° C. to 5° C./min, for example. It is preferred that the temperature drop rate is low because Zr is more evenly dispersed throughout the metal structure of the molded body and thus evenly distributed.

Then, the solution-treated sintered body is rapidly cooled at a cooling rate of 300° C./min or more (rapid cooling step S7). Further, the sintered body is continuously heated at a temperature of 700° C. to 870° C. for one hour or more under the same atmosphere condition, and consecutively cooled at a cooling rate of 0.2° C. to 1° C./min until it falls down to at least 600° C. or preferably to 400° C. or lower (aging treatment step S8).

By the above process, the permanent magnet according to the first embodiment is obtained.

### Experiment 1

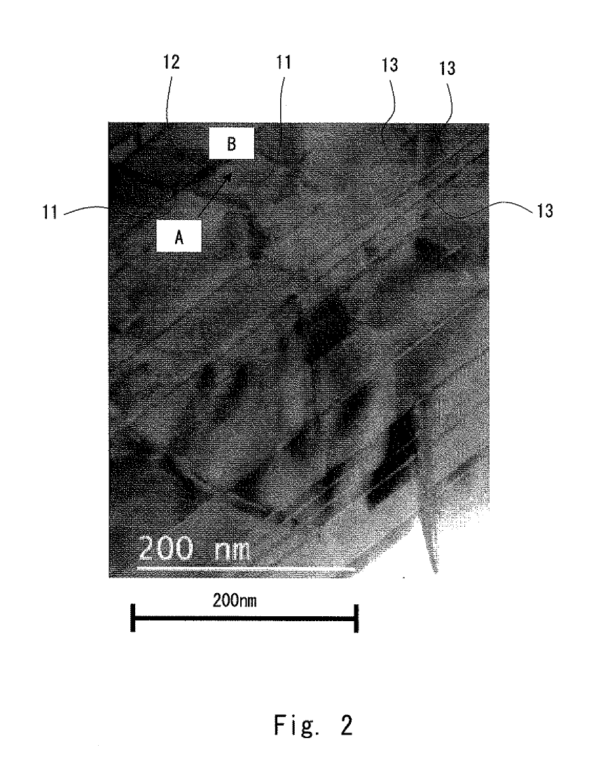

Hereinafter, experiments conducted as examples 1 to 3 for the permanent magnet according to the first embodiment and comparative examples 1 and 2 are described with reference to Table 1 and FIGS. 2 to 5.

In the examples 1 to 3, a permanent magnet was produced by the same production method as described above. To be specific, in the material combining step S1, a target composition was 25.0 wt % Sm, 4.4 wt % Cu, 20.0 wt % Fe, 2.4 wt % Zr, and the remainder Co. As the master alloy containing Zr, 20% Fe-80% Zr alloy was used. Further, in the powdering step S3, an ingot was finely ground to powder with an average particle diameter (d50) of 6 μm in an inert gas atmosphere by using a jet mill In the press molding step S4, press molding was performed under the conditions of a magnetic field of 15 kOe and a press-molding pressure value of 1.0 ton/cm². In the sintering step S5, sintering was performed at a sintering temperature of 1200° C. In the solution treatment step S6, the temperature was dropped to the solution temperature at a temperature drop rate of 1° C./min, and solution treatment was performed for four hours at a solution temperature of 1170° C. In the rapid cooling step S7, rapid cooling was performed at a cooling rate of 300° C./min In the aging treatment step S8, isothermal aging treatment was performed by continuously heating the sintered body for ten hours at a temperature of 850° C. in the inert gas atmosphere and, after that, continuous aging treatment was performed to 350° C. at a cooling rate of 0.5° C./min, thereby obtaining a permanent magnet material. The properties of the magnet obtained in this method were shown in Table 1 as the example 1.

In the example 2, a permanent magnet was produced by the same production method as the example 1 except that heat treatment that continuously heats the ingot for fifteen hours at 1170° C. was performed after the ingot casting step S2.

In the example 3, a permanent magnet was produced by the same production method as the production method of the permanent magnet according to the first embodiment described above except for the material combining step S1. In the production method of the example 3, 50% Cu-50% Zr alloy was used instead of 20% Fe-80% Zr alloy in the material combining step S1.

Note that, in the comparative example 1, a permanent magnet was produced by the same production method as the production method of the permanent magnet according to the first embodiment described above except for the material combining step S1. In the production method of the comparative example 1, Zr metal called zirconium sponge was used instead of 20% Fe-80% Zr alloy in the step corresponding to in the material combining step S1.

In the comparative example 2, a permanent magnet was produced by the same production method as the production method of the permanent magnet according to the first embodiment described above except for the ingot casting step S2. In the production method of the comparative example 2, strip casting was used in the step corresponding to the ingot casting step S2.

The magnetic properties in the examples 1 to 3 and the comparative examples 1 and 2 were measured. The measured magnetic properties were a remanence Br[T], a coercive force Hej[kA/m], a maximum energy product (BH)max[kJ/m³], and squareness Hk/Hcj[%]. The squareness Hk/Hcj indicates the squareness of a demagnetization curve, and a larger value indicates better magnetic properties. Hk is a value of Hc when B at a remanence Br of 90% and the demagnetization curve intersect. Further, a density and an average crystal grain diameter were also measured. The measured results are shown in Table 1. Further, the a-plane of the crystal of the cross-sectional structures in the example 1 and the comparative example 1 was observed using TEM (Transmission Electron Microscope). Further, the composition of each element in those cross-sectional structures was measured using TEM-EDX (Transmission Electron Microscope Energy Dispersive X-ray Spectroscopy).

TABLE 1

| | | | | | | Average |
|---|---|---|---|---|---|---|
| | | | | | | crystal |
| | | | (BH) | | | grain |
| | Br | HcJ | max | Hk/HcJ | Density | diameter |
| | (T) | (kA/m) | (kJ/m³) | (%) | (10³ × kg/m³) | (μm) |
| Example 1 | 1.15 | 1760 | 248 | 60 | 8.28 | 65 |
| Example 2 | 1.15 | 1680 | 252 | 64 | 8.28 | 80 |
| Example 3 | 1.15 | 1720 | 244 | 56 | 8.28 | 60 |
| Comparative | 1.15 | 1440 | 198 | 45 | 8.28 | 80 |
| Example 1 | | | | | | |
| Comparative | 1.10 | 2080 | 216 | 47 | 8.36 | 35 |
| Example 2 | | | | | | |

As shown in Table 1, in the example 1, in comparison with the comparative example 1, the remanence Br was the same level, the coercive force Hcj was 1200 kA/m or more, the energy product (BH)max was 200 kJ/m³ or more, and the squareness Hk/Hcj was 50% or more, all of which were suitable values. It is considered that this is because, in the example 1, FeZr alloy was used as a material and sufficiently dissolved in the ingot casting step S2, and thereby Zr was evenly distributed in the metal structure. On the other hand, it is considered that, in the comparative example 1, Zr metal called zirconium sponge was used and not sufficiently dissolved compared with the example 1 in the ingot casting step S2, and consequently Zr was unevenly distributed in the metal structure. Further, it was confirmed that the density of the permanent magnet obtained by the same production method as in the examples 1 to 3 was within the range of at least 8.15 to 8.39g/cm³.

In the example 2, the energy product (BH)max was higher compared with the example 1. It is considered that this is because the ingot was heat-treated after the ingot casting step S2 in the example 2, and thereby the metal structure was homogenized.

In the example 3, CuZr alloy was used instead of FeZr alloy as a material, and good magnetic properties were measured as in the example 1. It is considered that this is because the CuZr alloy, which was used as a material in this example, was also sufficiently dissolved in the ingot casting step S2, and Zr was evenly distributed in the metal structure.

On the other hand, it is considered that, in the comparative example 2, in comparison with the example 1, while the density and the coercive force Hcj were high, the remanence Br, the maximum energy product (BH)max and the squareness Hk/Hcj were low. Further, because the remanence Br was low despite that the density was high, it is considered that the degree of orientation of the crystal axis was low. A part of the reason for this is because the average crystal grain diameter was smaller than that of the examples 1 to 3 and the comparative example 1. It is preferred that the average crystal grain diameter is within the range of 40 to 100nm because the permanent magnet can have the suitable remanence Br, maximum energy product (BH)max and squareness Hk/Hcj.

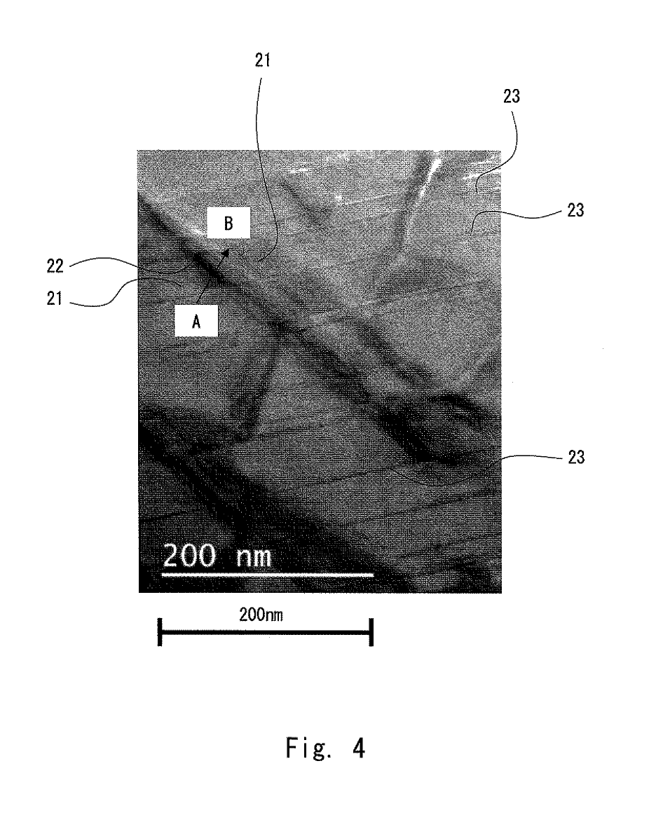

As shown in FIG. 2, in the cross-sectional structure of the example 1, the cell phases 11, the cell walls 12 and the plate phases 13 containing Zr were found in the crystal grain. The cell phases 11 contain Sm₂Co₁₇ phases, and the cell walls 12 contain SmCo₅ phases and are placed to surround the cell phases 11. The plate phases 13 containing Zr are plate-like phases containing Zr and are arranged in a certain direction in the crystal grains. As shown in FIG. 4, in the cross-sectional structure of the example 2 also, cell phases 21, cell walls 22 and plate phases 23 containing Zr were found just like in the cross-sectional structure of the example 1.

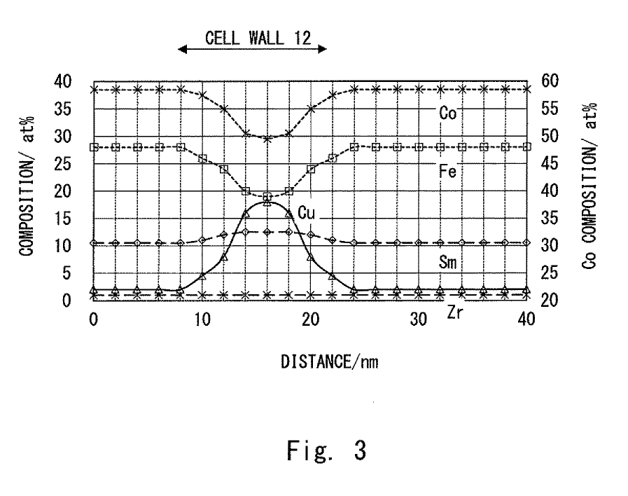

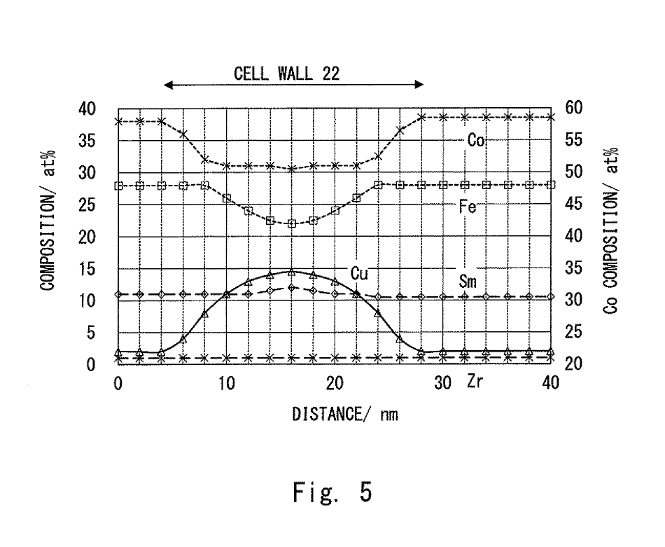

As shown in FIGS. 2 and 4, in the example 1 and the comparative example 1, each element composition was analyzed at intervals of 2 nm to go across the cell wall 12 from A to B. As shown in FIG. 3, in the example 1, the Cu composition reached its peak in the cell wall 12. The maximum value was 18.0 at%, and the half width of the peak was 8 nm. Further, as shown in FIG. 5, in the comparative example 1, the Cu composition reached its peak in the cell wall 22. The maximum value was 14.5 at %, which is lower than that of the example 1, and the half width of the peak was 11 nm, which is larger than that of the example 1. In the example 1, the peak of the Cu composition was higher and steeper compared with the comparative example 1, it is considered that the maximum energy product (BH)max and the squareness Hk/Hcj were high. Therefore, good magnetic properties were obtained in the example 1, and it is thus preferable as the permanent magnet. Further, it is preferred that the maximum value of the Cu composition of the cell wall is 15 at % or more because good magnetic properties are obtained. Furthermore, it is preferred that the half width of the peak of the Cu composition is 10 nm because the permanent magnet can have good magnetic properties.

### Experiment 2

Hereinafter, experiments conducted as examples 4 to 15 for the permanent magnet according to the first embodiment and comparative examples 3 to 10 are described with reference to Table 2.

TABLE 2

| | Br | HcJ | (BH)max | Hk/HcJ | Sm | Fe | Cu | Zr | Co |
|---|---|---|---|---|---|---|---|---|---|
| | (T) | (kA/m) | (kJ/m³) | (%) | (wt %) | | | | |
| Comparative | 1.10 | 720 | 192 | 43 | 22.5 | 20.0 | 4.4 | 2.5 | Remainder |
| Example 3 | | | | | | | | | |
| Example 4 | 1.17 | 1280 | 244 | 55 | 23.0 | 20.0 | 4.4 | 2.5 | Remainder |
| Example 5 | 1.13 | 1240 | 240 | 54 | 27.0 | 20.0 | 4.4 | 2.5 | Remainder |
| Comparative | 1.10 | 760 | 188 | 41 | 27.5 | 20.0 | 4.4 | 2.5 | Remainder |
| Example 4 | | | | | | | | | |
| Comparative | 1.13 | 1150 | 194 | 35 | 25.0 | 18.5 | 4.4 | 2.5 | Remainder |
| Example 5 | | | | | | | | | |
| Example 6 | 1.14 | 1360 | 240 | 52 | 25.0 | 19.0 | 4.4 | 2.5 | Remainder |
| Example 7 | 1.17 | 1720 | 252 | 58 | 25.0 | 22.0 | 4.4 | 2.5 | Remainder |
| Example 8 | 1.19 | 1680 | 248 | 54 | 25.0 | 24.0 | 4.4 | 2.5 | Remainder |
| Example 9 | 1.20 | 1280 | 240 | 50 | 25.0 | 25.0 | 4.4 | 2.5 | Remainder |
| Comparative | 1.18 | 760 | 190 | 35 | 25.0 | 25.5 | 4.4 | 2.5 | Remainder |
| Example 6 | | | | | | | | | |
| Comparative | 1.15 | 780 | 200 | 36 | 25.0 | 20.0 | 3.3 | 2.5 | Remainder |
| Example 7 | | | | | | | | | |
| Example 10 | 1.17 | 1240 | 240 | 51 | 25.0 | 20.0 | 3.5 | 2.5 | Remainder |
| Example 11 | 1.16 | 1680 | 244 | 55 | 25.0 | 20.0 | 4.0 | 2.5 | Remainder |
| Example 12 | 1.14 | 1780 | 240 | 52 | 25.0 | 20.0 | 5.0 | 2.5 | Remainder |
| Comparative | 1.12 | 1280 | 192 | 33 | 25.0 | 20.0 | 5.2 | 2.5 | Remainder |
| Example 8 | | | | | | | | | |
| Comparative | 1.15 | 750 | 195 | 43 | 25.0 | 20.0 | 4.4 | 1.3 | Remainder |
| Example 9 | | | | | | | | | |
| Example 13 | 1.19 | 1280 | 244 | 51 | 25.0 | 20.0 | 4.4 | 1.5 | Remainder |
| Example 14 | 1.17 | 1720 | 252 | 58 | 25.0 | 20.0 | 4.4 | 2.0 | Remainder |
| Example 15 | 1.13 | 1200 | 244 | 55 | 25.0 | 20.0 | 4.4 | 3.0 | Remainder |
| Comparative | 1.11 | 730 | 197 | 45 | 25.0 | 20.0 | 4.4 | 3.2 | Remainder |
| Example 10 | | | | | | | | | |

In the examples 4 to 15, materials were prepared with the component shown in Table 2 as a target composition, and a permanent magnet was produced by the same production method as the example 1. Further, the magnetic properties of the examples 4 to 15 and the comparative examples 3 to 10 were measured. Furthermore, each element composition of the cell wall in the examples 4 to 15 was measured in the same way as in the example 1 and the comparative example 1.

As shown in Table 2, in the examples 4 and 5, the coercive force Hcj was 1200 kA/m or more, the energy product (BH)max was 200 kJ/m³ or more, and the squareness Hk/Hcj was 50% or more, all of which were suitable values. On the other hand, in the comparative example 3, the content of Sm was smaller, 22.5 wt %, and the coercive force Hcj, the energy product (BH)max and the squareness Hk/Hcj were smaller in comparison with the examples 4 and 5. In the comparison example 4, the content of Sm was larger, 27.5 wt %, and the coercive force Hcj, the energy product (BH)max and the squareness Hk/Hcj were smaller in comparison with the examples 4 and 5. Accordingly, it is considered that, if the content of Sm is 23 to 27 wt %, the coercive force Hcj, the energy product (BH)max and the squareness Hk/Hcj are suitable values.

Further, in the examples 6 to 9, as in the examples 4 and 5, the coercive force Hcj was 1200 kA/m or more, the energy product (BH)max was 200kJ/m³ or more, and the squareness Hk/Hcj was 50% or more, all of which were suitable values. On the other hand, in the comparative example 5, the content of Fe was smaller, 18.5 wt %, and the coercive force Hcj, the energy product (BH)max and the squareness Hk/Hcj were smaller in comparison with the examples 6 to 9. In the comparison example 6, the content of Fe was larger, 25.5 wt %, and the coercive force Hcj, the energy product (BH)max and the squareness Hk/Hcj were smaller in comparison with the examples 6 to 9. Accordingly, it is considered that, if the content of Fe is 19 to 25 wt %, the coercive force Hcj, the energy product (BH)max and the squareness Hk/Hcj are suitable values.

Further, in the examples 10 to 12, as in the examples 4 to 9, the coercive force Hcj was 1200 kA/m or more, the energy product (BH)max was 200 kJ/m³ or more, and the squareness Hk/Hcj was 50% or more, all of which were suitable values. On the other hand, in the comparative example 7, the content of Cu was smaller, 3.3 wt %, and the coercive force Hcj and the squareness Hk/Hcj were smaller in comparison with the examples 10 to 12. In the comparison example 8, the content of Cu was larger, 5.2 wt %, and the energy product (BH)max and the squareness Hk/Hcj were smaller in comparison with the examples 10 to 12. Accordingly, it is considered that, if the content of Cu is 3.5 to 5.0 wt %, the coercive force Hcj, the energy product (BH)max and the squareness Hk/Hcj are suitable values.

Further, in the examples 13 to 15, as in the examples 4 to 12, the coercive force Hcj was 1200 kA/m or more, the energy product (BH)max was 200 kJ/m³ or more, and the squareness Hk/Hcj was 50% or more, all of which were suitable values. On the other hand, in the comparative example 9, the content of Zr was smaller, 1.3 wt %, and the coercive force Hcj, the energy product (BH)max and the squareness Hk/Hcj were smaller in comparison with the examples 13 to 15. In the comparison example 10, the content of Zr was larger, 3.2 wt %, and the coercive force Hcj, the energy product (BH)max and the squareness Hk/Hcj were smaller in comparison with the examples 13 to 15. Accordingly, it is considered that, if the content of Zr is 1.5 to 3.0 wt %, the coercive force Hcj, the energy product (BH)max and the squareness Hk/Hcj are suitable values.

Note that, each element composition of the cell wall in the examples 4 to 15 was measured in the same way as in the example 1 and the comparative example 1. As a result, in the cell wall, the maximum value of the Cu composition was 15 at % or more.

### Experiment 3

Hereinafter, experiments conducted as examples 16 to 19 for the permanent magnet according to the first embodiment and comparative examples 11 and 12 are described with reference to Table 3.

TABLE 3

| | | | (BH) | | | | |
|---|---|---|---|---|---|---|---|
| | Br | HcJ | max | Hk/HcJ | C | O | Al |
| | (T) | (kA/m) | (kJ/m³) | (%) | (ppm) | (ppm) | (ppm) |
| Example 16 | 1.15 | 1760 | 248 | 60 | 200 | 3000 | 500 |
| Example 17 | 1.12 | 1600 | 240 | 50 | 1000 | 3000 | 500 |
| Comparative | 1.08 | 1440 | 195 | 35 | 1100 | 3000 | 500 |
| Example 11 | | | | | | | |
| Example 18 | 1.17 | 1760 | 252 | 62 | 500 | 1000 | 500 |
| Example 19 | 1.13 | 1680 | 244 | 51 | 500 | 5000 | 500 |
| Comparative | 1.10 | 1400 | 196 | 40 | 500 | 5250 | 500 |
| Example 12 | | | | | | | |

In the examples 16 to 19, a permanent magnet was produced by the same production method as in the example 1 except that a target composition was an alloy consisting of 24.5 to 25.5 wt % Sm, 4.3 wt % Cu, 20.0 wt % Fe, 2.4 wt % Zr, and the remainder Co and that the content of C (Carbon), O (Oxygen) and Al as inevitable impurities were varied as shown in Table 3. The content of C (Carbon) was adjusted by changing the amount of a lubricant such as stearic acid or an addition method in the press molding step S4. The content of O (Oxygen) was adjusted by changing the particle diameter or the like at the time of fine grinding in the powdering step S3. The content of Al was adjusted by adding pure Al in the material combining step S1. Further, the magnetic properties of the examples 16 to 19 and the comparative examples and 12 were measured. Furthermore, each element composition of the cell wall in the examples 16 to 19 was measured in the same way as in the example 1 and the comparative example 1.

As shown in Table 3, in the examples 16 and 17, as in the examples 1 to 15, the coercive force Hcj was 1200 kA/m or more, the energy product (BH)max was 200 kJ/m³ or more, and the squareness Hk/Hcj was 50% or more, all of which were suitable values. On the other hand, in the comparative example 11, the content of C was larger, 1100 ppm, and the energy product (BH)max was smaller in comparison with the examples 16 and 17. Thus, if the content of C as an inevitable impurity is restricted to 200 to 1000 ppm, good magnetic properties are obtained.

In the examples 18 and 19, as in the examples 1 to 15, the coercive force Hcj was 1200 kA/m or more, the energy product (BH)max was 200 kJ/m³ or more, and the squareness Hk/Hcj was 50% or more, all of which were suitable values. On the other hand, in the comparative example 12, the content of O was larger, 5250 ppm, and the energy product (BH)max and the squareness Hk/Hcj were smaller in comparison with the examples 18 and 19. Thus, if the content of O as an inevitable impurity is restricted to 1000 to 5000 ppm or more preferably 1000 to 3500 ppm, good magnetic properties are obtained.

Note that, each element composition of the cell wall in the examples 16 to 19 was measured in the same way as in the example 1 and the comparative example 1. As a result, in the cell wall, the maximum value of the Cu composition was 15 at % or more.

Although the exemplary embodiment of the present invention is described in the foregoing, the present invention is not restricted to the above-described configuration, and various changes, modifications and combinations as would be obvious to one skilled in the art may be made without departing from the scope of the invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A rare earth-cobalt permanent magnet containing 23 to 27 wt % R, 3.5 to 5 wt % Cu, 19 to 25 wt % Fe, 1.5 to 3 wt % Zr, and a remainder Co with inevitable impurities, where an element R is a rare earth element at least containing Sm, wherein
the rare earth-cobalt permanent magnet has a density of 8.15 to 8.39 g/cm³,
the rare earth-cobalt permanent magnet has a metal structure including a cell phase containing Sm₂Co₁₇ phase and a cell wall surrounding the cell phase and containing SmCo₅ phase,
an average crystal grain diameter is within a range of 40 to 100 μm, and
a half width of Cu content of the cell wall is 10 nm or less.

2. The rare earth-cobalt permanent magnet according to claim 1, wherein a maximum value of Cu content of the cell wall is 15 at % or more.

3. The rare earth-cobalt permanent magnet according to claim 1, wherein among the inevitable impurities, C is restricted to 200 to 1000 ppm.

4. The rare earth-cobalt permanent magnet according to claim 1, wherein among the inevitable impurities, O is restricted to 1000 to 5000 ppm.
